(19) United States
(12) Patent Application Publication
(10) Pub. No.: US 2015/0358061 A1
(43) Pub. Date: Dec. 10, 2015

(54) RADIO BASE STATION AND METHOD FOR PRECODING SIGNAL

(71) Applicant: TELEFONAKTIEBOLAGET L M ERICSSON (PUBL), Stockholm (SE)

(72) Inventor: Haochuan Zhang, Beijing (CN)

(21) Appl. No.: 14/762,118

(22) PCT Filed: Jan. 23, 2013
(86) PCT No.: PCT/CN2013/070891

§ 371 Date: Jul. 20, 2015

(51) Int. Cl. H04B 7/04; H04L 27/26; H04W 72/04

(52) U.S. Cl. CPC H04B 7/0482; H04W 72/042; H04L 27/2627

(57) ABSTRACT

An RBS, operable in an OFDM based communication network, and a method performed by the RBS for precoding a signal to be sent on a distributed ePDCCH are provided. The RBS comprises N_{T} transmit antennas, the ePDCCH is transmitted over 2 antenna ports. The method comprising determining (110) an N_{T}*2 layer-to-antenna mapping matrix, W(i); determining (120) a 2*2 diagonal matrix, D(i), and determining (130) a 2*2 normalised Fast Fourier Transform, FFT, matrix, U. Precoding the signal is achieved by multiplying data to be sent in the signal by W(i), D(i), and U.

### TECHNICAL FIELD

The present disclosure relates to precoding of a signal, and in particular to precoding of a signal to be sent on a distributed enhanced Physical Downlink Control Channel, ePDCCH.

### BACKGROUND

A Radio Base Station, RBS, may be equipped with multiple transmit antennas in order to provide e.g. better coverage and/or increased capacity within its coverage area. When multiple transmit antennas are being used, a precoding scheme is needed by the distributed ePDCCH in order to benefit from the spatial diversity of the multiple transmit antennas, or the multiple antenna ports.

There are different ways of precoding a signal to be transmitted and different precoding schemes have different advantages and different drawbacks. One drawback of conventional random precoding is that it cannot guarantee either equal protection to the layers or orthogonality between two precoding vectors.

The ePDCCH is defined in 3^{rd} Generation Partnership Project, 3GPP, Release 11 of Long Term Evolution, LTE. The ePDCCH will carry Downlink Control Information, DCI, as an enhancement or compliment to the existing PDCCH defined in 3GPP release 8 of LTE.

The ePDCCH may decouple control channel structure from the cell and it may enable novel deployments and antenna structures, i.e. DeModulation Reference Signal, DM-RS, based control, e.g. Remote Radio Unit, RRU, based Heterogeneous Networks, shared cells, soft cells, decoupled uplink/downlink nodes.

The ePDCCH is expected to be used in various scenarios. One example is homogeneous networks to support user equipment, UE, specific beamforming and better utilisation of multiple antennas at the RBS, or eNodeB, and/or to avoid the interference problem when using legacy control channels.

Another example is with a new carrier type to provide a control channel without using Cell Specific Reference Signals, CRSs. Yet an example is shared cells, to cope with control channel capacity limitations, are splitting of control, to allow scheduling in low power RBSs for any backhaul.

Still an example of a scenario when ePDCCH is expected to be used is soft cells with DM-RS-based transmissions, wherein the set of sites used is transparent to the UE, for uplink/downlink decoupling of scheduling node. Yet another example is low cost Machine Type Communication, MTS, for configurable control signal bandwidth.

The ePDCCH will carry UE specific search space and it is supported for Time Division Duplex, TDD, and Frequency Division Duplex, FDD. Further, the ePDCCH spans both slots of a subframe and is frequency division multiplexed with Physical Downlink Shared Channel, PDSCH, in the subframe. The ePDCCH will use DM-RS for demodulation and it can be transmitted as localised to one Physical Resource Block, PRB, pair or distributed over multiple PRB pairs. The ePDCCH may operate in open loop (random precoding) or in closed loop operation (UE specific precoding) and it can be Multiple Users Multiple Input Multiple Output, MU-MIMO multiplexed transparent to the UE.

To fully exploit the spatial diversity offered by the use of multiple transmit antennas, a proper spatial precoding scheme for distributed ePDCCH is indispensible. The precoding scheme, however, is transparent to the specification. A most straightforward method is to use the so-called “random precoding,” where the precoding matrices are generated in certain random manner.

This random precoding, however, suffers from several drawbacks. One drawback is that it cannot guarantee equal protection within an ePDCCH set to the two layers/ports. Since the precoding vector for each DM-RS port is randomly selected for each Resource Block, RB, there is a risk that a bad precoder will continue to be chosen for the antenna port (or layer) that was not well precoded. Another drawback is that it may suffer from inter-layer (inter-stream) interference. The precoding vectors for the two layers are randomly selected, and as a result, they are not orthogonal to each other in most cases. In the presence of Radio Frequency, RF, imperfection like Error Vector Magnitude, EVM, such a non-orthogonality may result in interference between the two layers.

### SUMMARY

The object is to obviate at least some of the problems outlined above. In particular, it is an object to provide a Radio Base Station, RBS, and a method performed by the RBS for precoding a signal to be sent on a distributed ePDCCH.

According to an aspect a method performed by a Radio Base Station, RBS, operable in an Orthogonal Frequency Division Multiplexed, OFDM, based communication network, for precoding a signal to be sent on a distributed enhanced Physical Downlink Control Channel, ePDCCH, is provided. The RBS comprises N_{T} transmit antennas, the ePDCCH is transmitted over 2 antenna ports. The method comprises determining an N_{T}*2 layer-to-antenna mapping matrix, W(i); determining a 2*2 diagonal matrix, D(i), and determining a 2*2 normalised Fast Fourier Transform, FFT, matrix, U. The method further comprises precoding the signal by multiplying data to be sent in the signal by W(i), D(i), and U.

According to an aspect, a Radio Base Station, RBS, operable in an Orthogonal Frequency Division Multiplexed, OFDM, based communication network, adapted for precoding a signal to be sent on a distributed enhanced Physical Downlink Control Channel, ePDCCH is provided. The RBS comprises N_{T} transmit antennas. The ePDCCH is transmitted over 2 antenna ports. The RBS comprises a determining unit adapted to determine an N_{T}*2 layer-to-antenna mapping matrix, W(i), to determine a 2*2 diagonal matrix, D(i), and to determine a 2*2 normalised FFT matrix, U. The RBS further comprises a precoding unit adapted to precode the signal by multiplying data to be sent in the signal by W(i), D(i), and U.

The RBS and the method performed by the RBS have several advantages. An advantage is the provision of equal protection to the two layers or ports. The two antenna ports will exchange their precoding vectors in adjacent Physical Resource Blocks, PRBs. Assuming that a special correlation remains constant over the entire system bandwidth; one antenna port may have a better precoding effect than the other port on a given PRB. However, on the adjacent PRB, the precoding vectors for the two ports are swapped and the precoding effect of the former worse port is now better than the other port. Such a beam switching would provide equal protection to the two layers. The precoding vectors for any given PRB pair index i will be orthogonal since the two columns of the matrix D(i)*U are orthogonal to each other. This orthogonality is preserved in the precoding matrix PM(i), i.e. W(i)*D(i)*U, and as a result, the two precoded layers may suffer less from inter-stream interference.

### BRIEF DESCRIPTION OF DRAWINGS

Embodiments will now be described in more detail in relation to the accompanying drawings, in which:

FIG. 1 is a flowchart of a method performed by an RBS for precoding a signal to be sent on a distributed ePDCCH according to an exemplifying embodiment.

FIG. 2 is a block diagram of an RBS operable in an OFDM based communication network and adapted for precoding a signal to be sent on a distributed ePDCCH according to an exemplifying embodiment.

FIGS. 3a and 3b are illustrations of an example of precoding vectors are two antenna ports 107 and 108.

FIG. 4a illustrates possible layer-to-antenna mapping matrices according to an example.

FIG. 4b illustrates possible layer-to-antenna mapping matrices according to another example.

FIG. 4c illustrates possible layer-to-antenna mapping matrices according to still another example.

FIG. 5 is a flowchart illustrating spatial precoding for distributed ePDCCH.

FIG. 6 is a block diagram of the ePDCCH generation process.

FIG. 7 is a block diagram of an arrangement in an RBS operable in an OFDM based communication network and adapted for precoding a signal to be sent on a distributed ePDCCH according to an exemplifying embodiment.

### DETAILED DESCRIPTION

Briefly described, an RBS, operable in an OFDM based communication network, and a method performed by the RBS for precoding a signal to be sent on a distributed ePDCCH are provided. The precoding is performed in such a way that data is precoded by multiplying the data with a layer to antenna mapping matrix, a diagonal matrix and a normalised Fast Fourier Transform, FFT, matrix.

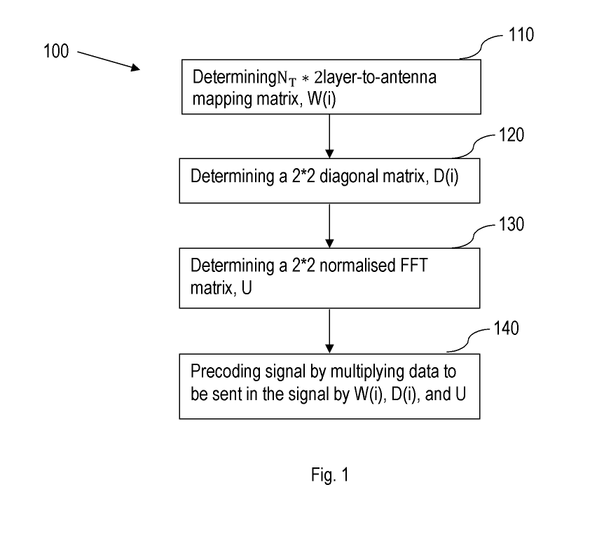

Exemplifying embodiments of such a method will now be described with reference to FIG. 1. The method is performed by an RBS operable in an OFDM based communication network. The RBS comprises N_{T} transmit antennas, the ePDCCH being transmitted over 2 antenna ports.

FIG. 1 illustrates the method 100 comprising determining 110 an N_{T}*2 layer-to-antenna mapping matrix, W(i); determining 120 a 2*2 diagonal matrix, D(i), and determining 130 a 2*2 normalised Fast Fourier Transform, FFT, matrix, U. The method further comprises precoding 140 the signal by multiplying data to be sent in the signal by W(i), D(i), and U.

The three different matrices, W(i), D(i), and U, when multiplied with each other generate a precoding matrix. In other words W(i)*D(i)*U=PM(i), where PM(i) is a precoding matrix for Physical Resource Block, PRB, pair i. The data to be sent in the precoded signal may be represented by.

$$[ \begin{matrix}{x}^{( {p}_{0} )} ( i ) \\ {x}^{( {p}_{1} )} ( i )\end{matrix} ]$$

Then the precoded signal to be sent through the physical N_{T} transmit antennas may be represented by

$$[ \begin{matrix}{y}^{( 0 )} ( i ) \\ {y}^{( {N}_{T} - 1 )} ( i )\end{matrix} ] ,$$

which is the result of

$${PM ( i )}^{*} [ \begin{matrix}{x}^{( {p}_{0} )} ( i ) \\ {x}^{( {p}_{1} )} ( i )\end{matrix} ] .$$

Index i is the index of

PRB pair within the distributed ePDCCH set. Each distributed ePDCCH set comprises several PRBs, e.g. 2, 4 or 8, wherein the PRB pair may be indexed within this set via 0, 1, . . . and so on. The symbols x^{(p}^{₀}⁾(i) and x^{(p}^{₁}⁾(i) represent data in the PRB pair of interest on the first and the second antenna port. The symbol y^{(t)}(i) represents the precoded signal to be sent over the t-th transmit antenna, where t=0, . . . , N_{T}−1 with N_{T}−1 being the total number of transmit antennas.

The 2*2 normalised FFT matrix, U, may be defined as

$$U = \frac{1}{\sqrt{2}} [ \begin{matrix}1 & 1 \\ 1 & {e}^{- j2π / 2}\end{matrix} ] .$$

The 2*2 diagonal matrix, D(i), may be defined as

$$D ( i ) = [ \begin{matrix}1 & 0 \\ 0 & {e}^{- j2πi / 2}\end{matrix} ] .$$

The layer-to-antenna mapping matrix, W(i) may be defined as W(i)=Cₖ with

$$k = ( ⌊ \frac{i}{2} ⌋ mod S ) ,$$

where S is the size of a set of matrices which will be explained in more detail below and Cₖ denotes the k-th matrix in the set. The different matrices U, D(i) and W(i) may be stored in a memory within the RBS, may be requested and obtained from a database within the communication network, or they may be transmitted to the RBS from e.g. an Operation, Administration and Maintenance, OAM, node or service. However, the matrices U and D(i) are the keys for equal protection and inter-vector orthogonality. All RBSs should use the same D(i) and U. Therefore, the matrices U and D(i) may be stored in a memory within the RBS, e.g. during the initialization phase, and will probably not change very frequently. However, the group of predefined matrices {C_k} has certain freedom, as far as the condition that the group of matrices should span a linear space of proper dimension is fulfilled. Explanation for this required condition will be detailed below.

The precoding matrix D(i)*U provides equal protection to the two layers because the precoding vectors are alternatively applied to the two ports on adjacent PRBs. This may be referred to as beam switching pattern. The third matrix, W(i), cyclically introduces another tier of precoding, in the purpose of increasing the frequency selectivity of the channel and gain more diversity in the special domain.

The method performed by the RBS may have several advantages. The method may provide equal protection to the two layers or ports. The two antenna ports will exchange their precoding vectors in adjacent PRBs. Assuming that a special correlation remains constant over the entire system bandwidth, one antenna port may have a better precoding effect than the other port on a given PRB. However, on the adjacent PRB, the precoding vectors for the two ports are swapped and the precoding effect of the former worse port is now better than the other port. Such a beam switching would provide equal protection to the two layers. The precoding vectors for any given PRB pair index i will always be orthogonal since the two columns of the matrix D(i)*U are always orthogonal to each other. This orthogonality is preserved in the precoding matrix PM(i), i.e. W(i)*D(i)*U, and as a result, the two precoded layers may suffer less from inter-stream interference.

According to an embodiment, the precoding is performed per PRB pair.

As described above, the data on a Resource Element, RE, in the PRB pair on the first antenna port may be represented by x^{(p}^{₀}⁾(i) and x^{(p}^{₁}⁾(i) may represent data on an RE in the PRB pair on the second antenna port for PRB pair i. Further, the precoding matrix PM(i) is described above, wherein i again is the index of PRB pair i.

According to still an embodiment, a precoding matrix for the i-th PRB pair is obtained from W(i)*D(i)*U, where i is the index of the PRB in a ePDCCH set.

Also described above is that the precoded matrix PM(i) is obtained by the multiplication of the three determined matrices, the layer-to-antenna mapping matrix, W(i); the diagonal matrix, D(i), and the normalised FFT, matrix U. When multiplying data on REs on PRB pair i with the PM(i), the precoded signal with regards to PRB pair i is obtained, which precoded signal is to be sent through the physical antenna. The index i starts from 0.

According to yet an embodiment, the antenna ports over which the distributed ePDCCH is transmitted are DeModulation Reference Signal, DM-RS, ports.

To allow for coherent demodulation at the user equipment, reference symbols (or pilot symbols) are inserted in the OFDM time-frequency grid to allow for channel estimation. One example of reference signals are DM-RS. The DM-RS inform the recipient of the signal how to demodulate data.

DM-RS ports in the downlink, DL, are similar to Cell-Specific Reference Signal, CRS, ports and Channel State Information Reference Symbol, CSI-RS. ports. All these ports are defined in the process of layer” to “port” to “antenna” mapping. For CRS, the spatial precoding defined in 3^{rd} Generation Partnership Project, 3GPP, LTE specification, also known as codebook based precoding, is actually the layer-to-port mapping. For CRS, the port-to-antenna mapping is not defined by the 3GPP LTE specification to provide flexibility in the deployment of antennas, e.g. many operators have 8 physical antennas but at most 4 CRS ports are defined in LTE.

For DM-RS ports, the precoding is the port-to-antenna mapping, and thus as described above, this mapping is transparent to the 3GPP LTE specification. For DM-RS, the layer-to-port mapping is not needed, since one layer corresponds to one DM-RS port.

According to an embodiment, determining the layer-to-antenna mapping matrix, W(i), comprises selecting one layer-to-antenna mapping matrix out of a number of predefined layer-to-antenna mapping matrices.

The RBS may comprise a memory in which a number of predefined layer-to-antenna mapping matrices is stored and the RBS may then select one of the stored predefined layer-to-antenna mapping matrices. Alternatively, the RBS may receive the predefined layer-to-antenna mapping matrices from another network node, e.g. an OAM node or OAM function. Once the predefined precoding matrices are settled, the RBS selects a precoding matrix out of the predefined ones in a cyclic manner. For instance, 4 matrices, C0, C1, C2, and C3, are predefined. Then, PRB#0 and #1 will use C0, PRB#2 and #3 will use C1, PRB#4 and #5 will use C2, PRB#6 and #7 will use C3. After that, PRB#8 and #9 will use C1 again, and the pattern repeat itself again. Alternatively, the RBS may determine which one to use according to a criterion.

According to still an embodiment, the predefined layer-to-antenna mapping matrices span a linear space of dimension equal to the number of transmit antennas, N_{T}.

As described above, there are two steps in the precoding via W(i): (1) find a group of precoding matrices, and (2) for each PRB, select one precoding matrix out of the ones above in a cyclic manner. The precoding/beamforming will concentrate the energy along a certain direction. The criterion that a group of matrices should span a linear space of proper dimension ensures that precoding via W(i) can cover all spatial directions (given that the number of PRB is sufficiently large).

With the above described embodiments of the method for precoding of ePDCCH, equal protection of the two layers and less inter-stream interference between the two ports may be obtained.

Embodiments herein also relate to a RBS, operable in an OFDM based communication network, the RBS being adapted for precoding a signal to be sent on a distributed ePDCCH. The RBS comprises N_{T}transmit antennas and the ePDCCH being transmitted over 2 antenna ports. The RBS has the same technical features, objects and advantages as the method performed by the RBS. The RBS will be described in brief in order to avoid unnecessary repetition.

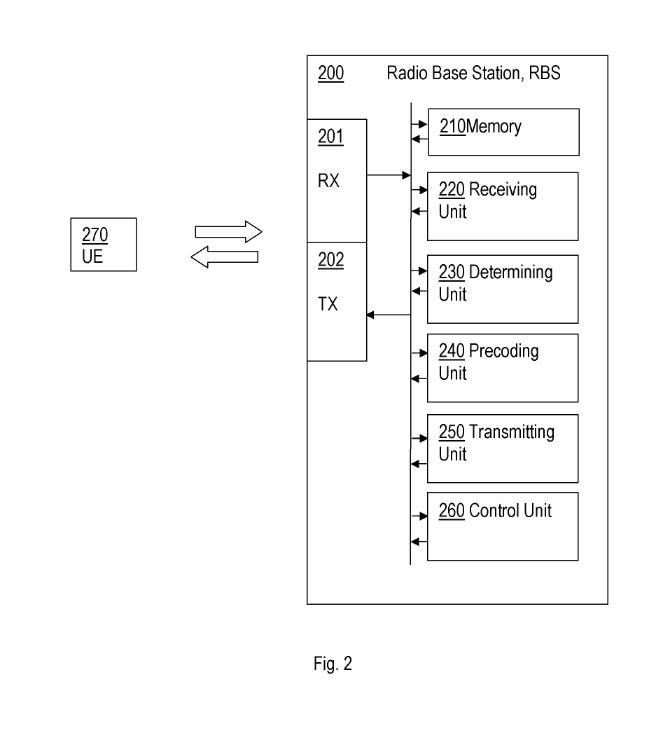

Such a RBS will now be briefly described with reference to FIG. 2, which is a block diagram of an RBS operable in an OFDM based communication network and adapted for precoding a signal to be sent on a distributed ePDCCH according to an exemplifying embodiment.

FIG. 2 illustrates the RBS comprising a determining unit 230 adapted to determine an N_{T}*2 layer-to-antenna mapping matrix, W(i), to determine a 2*2 diagonal matrix, D(i), and to determine a 2*2 normalised FFT matrix, U. The RBS further comprises a precoding unit 240 adapted to precode the signal by multiplying data to be sent in the signal by W(i), D(i), and U.

The RBS may have several advantages. The RBS may provide equal protection to the two layers or ports. The two antenna ports will exchange their precoding vectors in adjacent PRBs. Assuming that a special correlation remains constant over the entire system bandwidth, one antenna port may have a better precoding effect than the other port on a given PRB. However, on the adjacent PRB, the precoding vectors for the two ports are swapped and the precoding effect of the former worse port is now better than the other port. Such a beam switching would provide equal protection to the two layers. The precoding vectors for any given PRB pair index i will always be orthogonal since the two columns of the matrix D(i)*U are always orthogonal to each other. This orthogonality is preserved in the precoding matrix PM(i), i.e. W(i)*D(i)*U, and as a result, the two precoded layers may suffer less from inter-stream interference.

According to an embodiment, the precoding unit 240 is further adapted to perform the precoding per PRB pair.

According to still an embodiment, the precoding unit 240 is further adapted to obtain a precoding matrix for the i-th PRB pair from W(i)*D(i)*U, where i is the index of the PRB in a ePDCCH set.

According to yet an embodiment, the antenna ports over which the distributed ePDCCH is transmitted are DM-RS ports.

According to still an embodiment, the determining unit 230 is adapted to determine the N_{T}*2 layer-to-antenna mapping matrix, W(i), by selecting one layer-to-antenna mapping matrix out of a number of predefined layer-to-antenna mapping matrices.

Generally speaking, ePDCCH is a control channel carrying DCI that is transmitted in a similar way as PDSCH (DM-RS-based reception, allows for beam-forming and better utilization of multiple antenna eNB). The ePDCCH is frequency multiplexed with PDSCH, the start OFDM symbol is configurable or following the Physical Control Format Indicator Channel, PCFICH, the ePDCCH spans both slots in subframe, and the UE monitors UE specific search space in ePDCCH and Common search space in PDCCH.

In the physical layer, an ePDCCH comprises L enhanced Control Channel Element, eCCE, where eCCE is the aggregation level L={1,2,4,8,16,32}; and each eCCE is split into 4 or 8 enhanced Resource Element Group, eREG, depending on CP length and subframe type. Further, there are 4 eREG per eCCE in a normal subframe and normal Cyclic Prefix, CP, length, and 1 eREG=9 RE in case of normal CP length; 1 eREG=8 RE in case of extended CP length.

Two mappings are supported. Distributed ePDCCH: the eREGs belonging to an ePDCCH is distributed in up to N PRB pairs, called a set of PRB pairs; the ePDCCH is further split on to two antenna ports per PRB pair to provide spatial diversity. Localized ePDCCH: the eREG belonging to an ePDCCH is localized within one (or more for high L) PRB pairs; one antenna port per PRB pair is used to efficiently support UE specific precoding.

UE can be configured with 3 sets of N_{—}1,N_{—}2, and N_{—}3 PRB pairs respectively to be used for ePDCCH, where sets can have different size, N_i={2,4,8}; each set is configured to either localized or distributed.

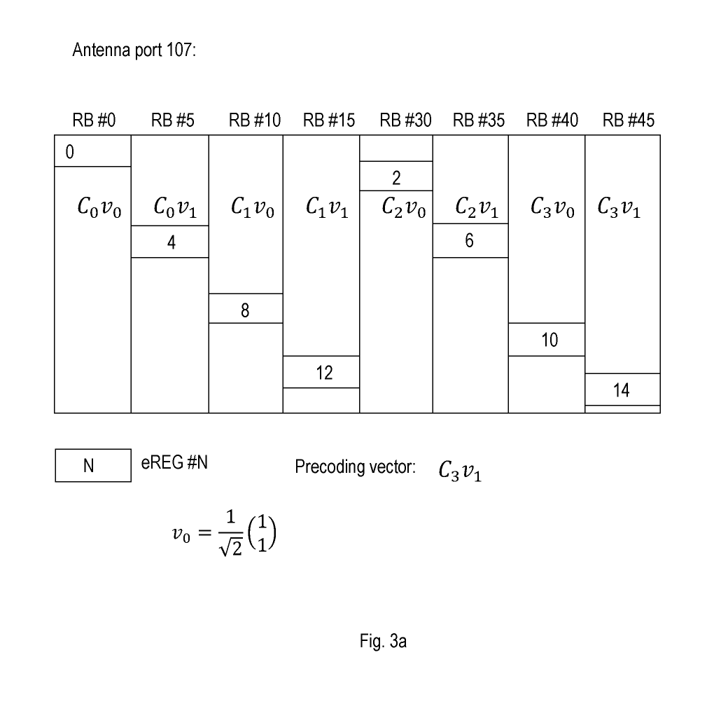

Below follows an illustrative example of how to precode a distributed ePDCCH according to the embodiments described above. In the example, described in conjunction with FIGS. 3a and 3b, three assumptions are made: (1) the system bandwidth is 10 MHz and the RBS has N_{T}=4 transmit antennas (2) a distributed ePDCCH set comprises 8 PRB pairs, i.e. PBR #0, #5, #10, #15, #30, #35, #40, and #45, which are indexed as i=0, 1, 2, . . . , 7, (3) 1 ePDCCH=2 enhanced Control Channel Element, eCCE, and 1 eCCE=4 enhanced Resource Element Group, eREG.

As described above, the layer-to-antenna mapping matrix, W(i), is determined, or selected from a number of predefined layer-to-antenna mapping matrices for every PRB pair. For example, if there are 4 predefined layer-to-antenna mapping matrices C₀, C₁, C₂, C₃, then W(i) [symbol] {C₀, C₁, C₂, C₃}. The Matrices D(i) and U are defined as above. The precoding procedure is illustrated in FIGS. 3a and 3b. Looking at FIGS. 3a and 3b, it is illustrated that for RB #0, the precoding vector for the first DM-RS port, antenna port 107 in FIG. 3a, is C₀v₀, while the precoding vector for the second DM-RS port, antenna port 108 in FIG. 3b, is C₀v₁. However, in RB #5, the two precoding vectors swap so that the precoding vector for the first DM-RS port, antenna port 107 in FIG. 3a, is C₀v₁, while the precoding vector for the second DM-RS port, antenna port 108 in FIG. 3b, is C₀v₀. In this manner, a “beam switching” pattern is formed among each pair of two adjacent PRBs. Assuming that the spatial correlation remains constant over the system bandwidth, which usually is the case for closely spaced antenna arrays widely used by in LTE, such a beam switching is advantageous since it provides equal protection to the two layers or ports.

Below, the layer-to-antenna mapping matrix, W(i) will be described i more detail. The W(i) is determined by selecting one matrix out of a number of predefined matrices. The structure of the precoding guarantees, or enables, a good precoding effect, as long as each layer-to-antenna mapping matrix can span a linear space of dimension equal to the number of transmit antennas, N^{T} of the RBS.

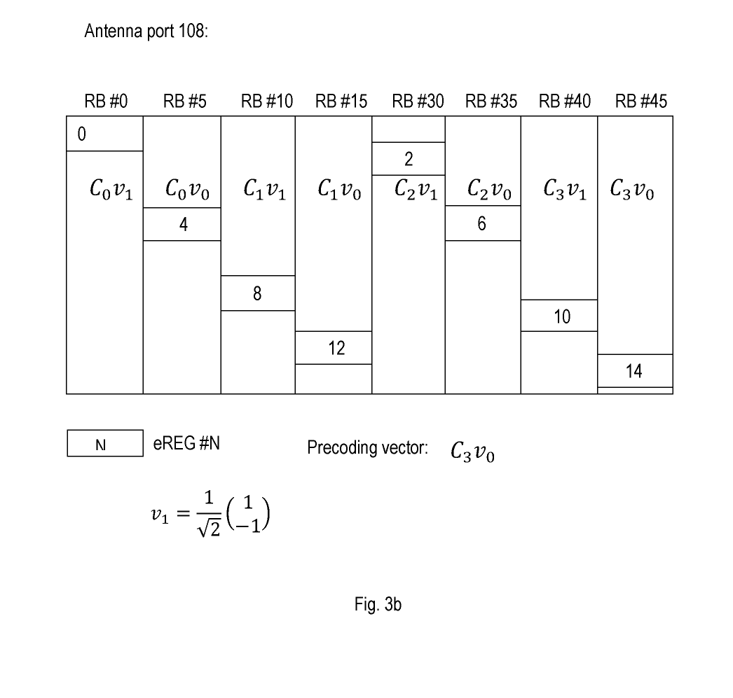

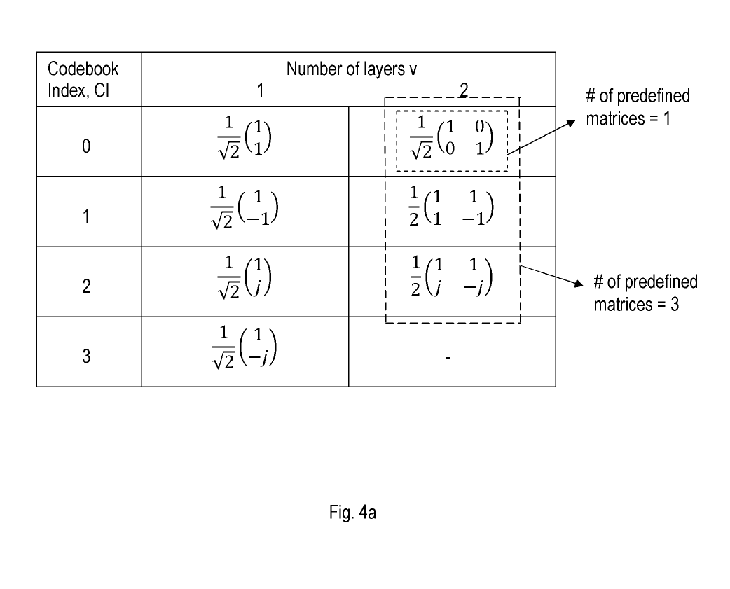

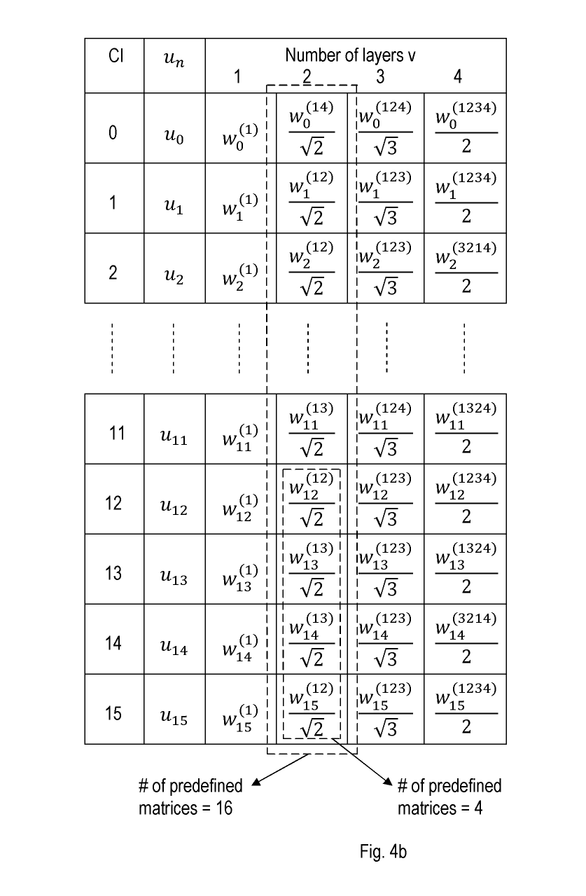

For the case of 2 transmit antennas, the set of layer-to-antenna matrices may be selected from the column with v=2 in Table 6.3.4.2.3-1 of 3^{rd} Generation Partnership Project, 3GPP, Technical Specification, TS 36.211 v10, also illustrated in FIG. 4a. The number of predefined matrices may vary from 1 to 3.

FIG. 4a illustrates possible layer-to-antenna mapping matrices according to Table 6.3.4.2.3-1 of 3GPP TS 36.211 v10.

For the case of 4 transmit antennas, the set of layer-to-antenna matrices may be selected from the column with v=2 in Table 6.3.4.2.3-2 of 3^{rd} 3GPP TS 36.211 v10, also illustrated in FIG. 4b. The number of predefined matrices may vary from 1 to 16.

FIG. 4b illustrates possible layer-to-antenna mapping matrices according to Table 6.3.4.2.3-2 of 3GPP TS 36.211 v10. FIG. 4b is simplified, e.g. codebook indices 3-10 are not shown and the column for uₙ is not complete.

For the case of 8 transmit antennas, the set of layer-to-antenna matrices may be selected from Table 6.3.4.2.3-4 of 3^{rd} 3GPP,TS 36.211 v10, also illustrated in FIG. 4c. The size of the number of predefined matrices may vary from 1 to 256.

FIG. 4c illustrates possible layer-to-antenna mapping matrices according to Table 6.3.4.2.3-4 of 3GPP TS 36.211 v10.

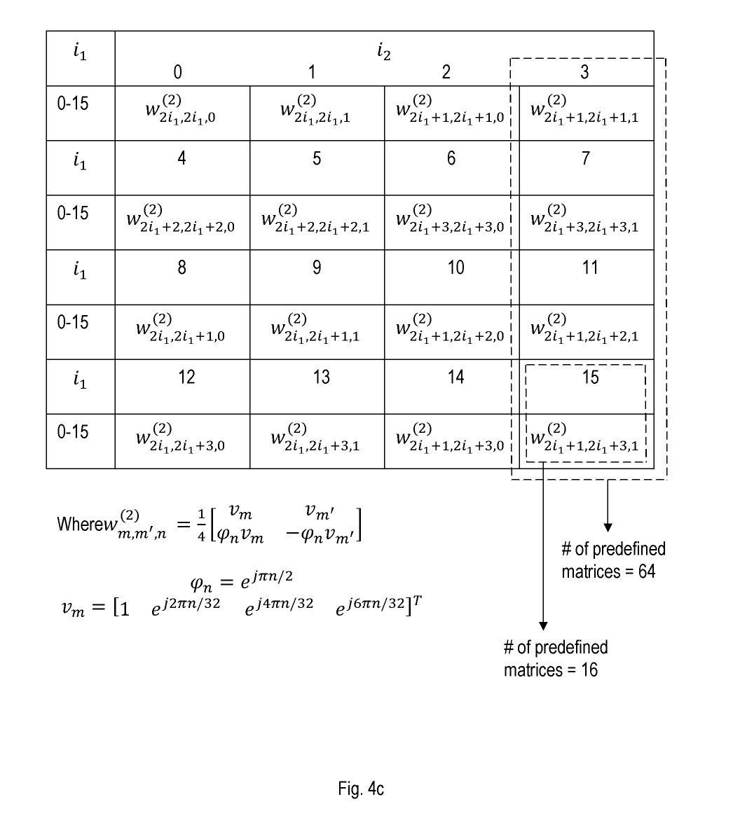

FIG. 5 illustrates the spatial precoding for distributed ePDCCH comprising determining 510 a 2*2 normalised FFT matrix U and multiplying the data of the ePDCCH on two DM-RS ports with the 2*2 normalised FFT matrix U, i.e. data*U. Further, a 2*2 diagonal matrix D(i) is determined 520 and the multiplied data and matrix U are multiplied with the 2*2 diagonal matrix, D(i), i.e. data*U*D(i). Still further FIG. 5 illustrates determining 530 an layer-to-antenna mapping matrix W(i) and multiplying the layer-to-antenna mapping matrix W(i) with the multiplied data, matrix U and matrix D(i), i.e. data*U*D(i)*W(i). As can be seen from FIG. 5 also looking at FIG. 1, the internal order of the multiplication of the different matrices with the data is irrelevant. The respective matrices are determined as described above and the data of ePDCCH on the two DM-RS ports are then multiplied with the three respective matrices. FIG. 5 further illustrates that the matrices D(i) and W(i) are performed per PRB pair within the ePDCCH set.

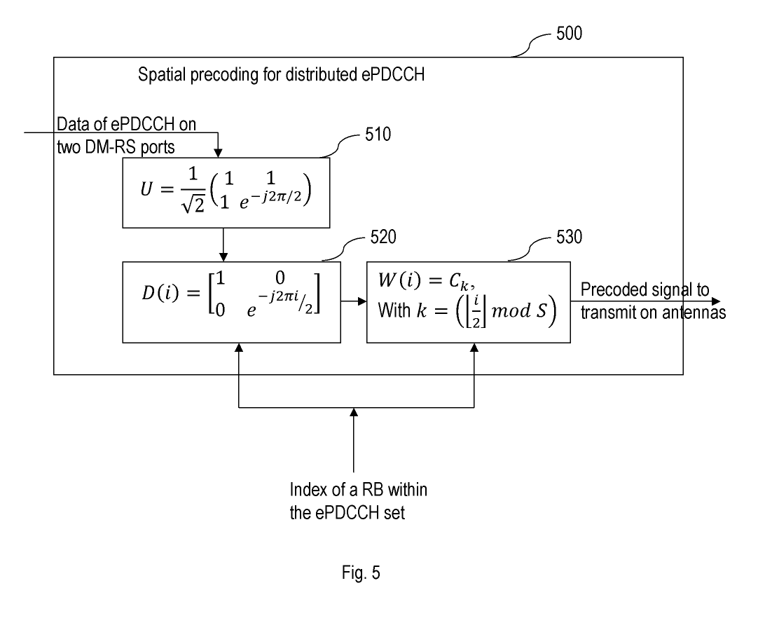

FIG. 6 is a block diagram of the ePDCCH generation process. Downlink Control Information, DCI, is first channel coded 610 and then modulated 620. The result of the channel coding and modulation of the DCI is the mapped on Resource Elements, REs, which is a form of time and frequency multiplexing (T/F multiplexing) in OFDM. This will result in data of the ePDCCH. Thereafter, this data is spatially precoded 640 which correspond to the process 500 described in FIG. 5.

In FIG. 2, the RBS 200 is also illustrated comprising a receiving arrangement RX 201 and a transmitting arrangement TX 202. Through these two arrangements, the RBS 700 is adapted to communicate with other nodes and/or entities in the wireless communication network. The receiving arrangement 201 may comprise more than one receiving arrangement. For example, the receiving arrangement may be connected to both a wire and an antenna, by means of which the RBS 200 is enabled to communicate with other nodes and/or entities in the wireless communication network. Similarly, the transmitting arrangement 202 may comprise more than one transmitting arrangement, which in turn is connected to both a wire and an antenna, by means of which the RBS 200 is enabled to communicate with other nodes and/or entities in the wireless communication network. The RBS 200 may further comprise a memory 210 for storing data. Further, the RBS 200 is illustrated comprising a control or processing unit 260 which in turns is connected to the different units 220-250. It shall be pointed out that this is merely an illustrative example and the RBS 200 may comprise more, less or other units/arrangements or modules which execute the functions of the RBS 200 in the same manner as the units illustrated in FIG. 2.

It should be noted that FIG. 2 merely illustrates various functional units in the RBS 200 in a logical sense. The functions in practice may be implemented using any suitable software and hardware means/circuits etc. Thus, the embodiments are generally not limited to the shown structures of the RBS 200 and the functional units. Hence, the previously described exemplary embodiments may be realised in many ways. For example, one embodiment includes a computer-readable medium having instructions stored thereon that are executable by the control or processing unit 260 for executing the method steps in the RBS 200. The instructions executable by the computing system and stored on the computer-readable medium perform the method steps of the RBS 200 as set forth in the claims.

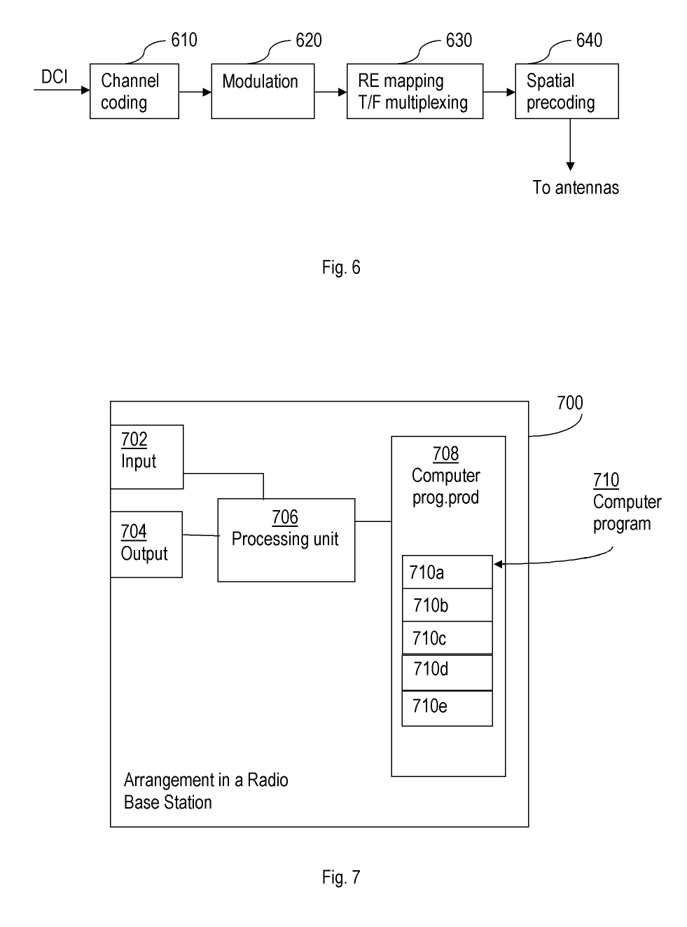

FIG. 7 is a block diagram of an arrangement in the RBS operable in an OFDM based communication network and adapted for precoding a signal to be sent on a distributed ePDCCH according to an exemplifying embodiment.

FIG. 7 schematically shows an embodiment of an arrangement 700 in an RBS. Comprised in the arrangement 700 in the RBS are here a processing unit 706, e.g. with a DSP (Digital Signal Processor). The processing unit 706 may be a single unit or a plurality of units to perform different actions of procedures described herein. The arrangement 700 in the RBS may also comprise an input unit 702 for receiving signals from other entities, and an output unit 704 for providing signal(s) to other entities. The input unit and the output unit may be arranged as an integrated entity or as illustrated in the example of FIG. 2, as one or more interfaces 201/202.

Furthermore, the arrangement 700 in the RBS comprises at least one computer program product 708 in the form of a non-volatile memory, e.g. an EEPROM (Electrically Erasable Programmable Read-Only Memory), a flash memory and a hard drive. The computer program product 708 comprises a computer program 710, which comprises code means, which when executed in the processing unit 706 in the arrangement 700 in the RBS causes the arrangement 700 in the RBS to perform the actions e.g. of the procedure described earlier in conjunction with FIG. 1.

The computer program 710 may be configured as a computer program code structured in computer program modules 710a-710e. Hence, in an exemplifying embodiment, the code means in the computer program of the arrangement 700 in the RBS comprises a determining unit, or module, for determining, an layer-to-antenna mapping matrix, W(i), for determining a 2*2 diagonal matrix, D(i), and for determining a 2*2 normalised FFT matrix, U. The computer program further comprises a precoding unit for precoding the signal by multiplying data to be sent in the signal by W(i), D(i), and U.

The computer program modules could essentially perform the actions of the flow illustrated in FIG. 1, to emulate the arrangement 700 in the RBS. In other words, when the different computer program modules are executed in the processing unit 706, they may correspond to the units 220-250 of FIG. 2.

Although the code means in the embodiments disclosed above in conjunction with FIG. 2 are implemented as computer program modules which when executed in the respective processing unit causes the RBS to perform the actions described above in the conjunction with figure mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as ASICs (Application Specific Integrated Circuit). The processor may also comprise board memory for caching purposes. The computer program may be carried by a computer program product connected to the processor. The computer program product may comprise a computer readable medium on which the computer program is stored. For example, the computer program product may be a flash memory, a RAM (Random-access memory) ROM (Read-Only Memory) or an EEPROM, and the computer program modules described above could in alternative embodiments be distributed on different computer program products in the form of memories within the RBS.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure may be regarded as logical entities and not necessity as separate physical entities.

While the embodiments have been described in terms of several embodiments, it is contemplated that alternatives, modifications, permutations and equivalents thereof will become apparent upon reading of the specifications and study of the drawings. It is therefore intended that the following appended claims include such alternatives, modifications, permutations and equivalents as fall within the scope of the embodiments and defined by the pending claims.

1. A method performed by a Radio Base Station, RBS, operable in an Orthogonal Frequency Division Multiplexed, OFDM, based communication network, for precoding a signal to be sent on a distributed enhanced Physical Downlink Control Channel, ePDCCH, the RBS comprising transmit antennas, the ePDCCH being transmitted over 2 antenna ports, the method comprising:
determining an layer-to-antenna mapping matrix, W(i),
determining a 2*2 diagonal matrix, D(i),
determining a2*2 normalised Fast Fourier Transform, FFT, matrix, U, and
precoding the signal by multiplying data to be sent in the signal by W(i), D(i), and U.

2. A method according to claim 1, wherein the precoding is performed per Physical Resource Block, PRB, pair.

3. A method according to claim 2, wherein a precoding matrix for the i-th PRB pair is obtained from W(i)*D(i)*U, where i is the index of the PRB in a ePDCCH set.

4. A method according to claim 1, wherein the antenna ports over which the distributed ePDCCH is transmitted are DeModulation Reference Signal, DMRS, ports.

5. A method according to claim 1, wherein determining the layer-to-antenna mapping matrix, W(i), comprises selecting one layer-to-antenna mapping matrix out of a number of predefined layer-to-antenna mapping matrices.

6. A method according to claim 1, wherein the predefined layer-to-antenna mapping matrices span a linear space of dimension equal to the number of transmit antennas.

7. A Radio Base Station, RBS, operable in an Orthogonal Frequency Division Multiplexed, OFDM, based communication network, adapted for precoding a signal to be sent on a distributed enhanced Physical Downlink Control Channel, ePDCCH, the RBS comprising transmit antennas, the ePDCCH being transmitted over 2 antenna ports, the RBS comprising:
a determining unit adapted to determine an layer-to-antenna mapping matrix, W(i), to determine a 2*2 diagonal matrix, D(i), and to determine a 2*2 normalised Fast Fourier Transform, FFT, matrix, U, and
a precoding unit adapted to precode the signal by multiplying data to be sent in the signal by W(i), D(i), and U.

8. An RBS according to claim 7, wherein the precoding unit is further adapted to perform the precoding per Physical Resource Block, PRB, pair.

9. An RBS according to claim 8, wherein the precoding unit is further adapted to obtain a precoding matrix for the i-th PRB pair from W(i)*D(i)*U, where i is the index of the PRB in a ePDCCH set.

10. An RBS according to claim 7, wherein the antenna ports over which the distributed ePDCCH is transmitted are DeModulation Reference Signal, DMRS, ports.

11. An RBS according to claim 7, wherein the determining unit is adapted to determine the layer-to-antenna mapping matrix, W(i), by selecting one layer-to-antenna mapping matrix out of a number of predefined layer-to-antenna mapping matrices.

12. An RBS according to claim 7, wherein the predefined layer-to-antenna mapping matrices span a linear space of dimension equal to the number of transmit antennas.

13. A computer program comprising computer readable code, which when run in one or more processing units, causes a Radio Base Station, RBS, to perform the procedure according to claim 1.

14. A computer program product, comprising the computer program according to claim 13.
